(19) United States
(12) Patent Application Publication
(10) Pub. No.: US 2013/0067729 A1
(43) Pub. Date: Mar. 21, 2013

(54) BATTERY ELECTRODE MANUFACTURING METHOD AND BATTERY MANUFACTURING METHOD

(71) Applicants: Kuniko TERAKI, Kyoto (JP); Kenta HIRAMATSU, Kyoto (JP); Takeshi MATSUDA, Kyoto (JP); Koji FURUICHI, Kyoto (JP); Masakazu SANADA, Kyoto (JP)

(72) Inventors: Kuniko TERAKI, Kyoto (JP); Kenta HIRAMATSU, Kyoto (JP); Takeshi MATSUDA, Kyoto (JP); Koji FURUICHI, Kyoto (JP); Masakazu SANADA, Kyoto (JP)

(21) Appl. No.: 13/530,878

(22) Filed: Jun. 22, 2012

(30) Foreign Application Priority Data
Sep. 20, 2011 (JP) 2011-204944

(51) Int. Cl. H01M 4/04

(52) U.S. Cl. 29/623.5; 427/58

(57) ABSTRACT

In a technology for manufacturing a battery electrode by applying an application liquid containing an active material, stripe-shaped pattern elements are formed at narrower intervals than before while contact between the pattern elements is avoided. An application liquid containing an active material is applied onto a base material 11, which will become a current collector, by a nozzle-scan coating method, thereby forming stripe-shaped active material pattern elements P1, P3, P5, . . . parallel to each other and extending in a Y-direction. After liquid components are volatilized from the application liquid and spread base parts of the pattern elements are shrunk, pattern elements P2, P4, P6, . . . are formed by applying the application liquid in stripes between the already formed pattern elements. In this way, it can be prevented that the base parts approach each other and the pattern elements touch each other when the adjacent patterns are simultaneously formed.

### CROSS REFERENCE TO THE RELATED APPLICATION

The disclosure of Japanese Patent Application No.2011-204944 filed on Sep. 20, 2011 including specification, drawings and claims is incorporated herein by reference in its entirety.

### BACKGROUND OF THE INVENTION

1. Field of the Invention

This invention relates to a method for manufacturing a battery electrode by applying an application liquid containing an active material to a base material and a method for manufacturing a battery using the electrode.

2. Description of the Related Art

As a method for producing a chemical battery such as a lithium-ion secondary battery, the applicant of this application previously disclosed a technology for forming one electrode by applying an application liquid containing an active material in stripes on a surface of a base material, which will become a current collector, and laminating an electrolyte layer and another electrode on the one electrode (JP2011-070788A). In this technology, by a nozzle-scan coating method for moving and scanning a nozzle including discharge openings for discharging an application liquid relative to the base material surface, the application liquid containing the active material is applied to the base material surface from the nozzle in which a multitude of discharge openings are arranged in a predetermined direction to form a multitude of stripe-shaped active material pattern elements parallel to each other.

In the nozzle-scan coating method for discharging the application liquid while the nozzle is moved to scan relative to the base material surface, the application liquid immediately after application may spread on the base material particularly when the viscosity of the application liquid is low or when wettability to the substrate is good. In the above conventional technology, this needs to be considered in setting an interval between adjacent pattern elements.

On the other hand, higher density of active material pattern elements is also required to further improve battery performance, more specifically, battery capacity and charge/discharge characteristics, and it is necessary to narrow intervals between parallel pattern elements. In this case, in the above conventional technology, there is a possibility that the adjacent pattern elements touch each other due to the spread of the application liquid immediately after the application and it is difficult to deal with such a request as to increase the density of the pattern elements. In this respect, there is a room for improvement in the above conventional technology.

### SUMMARY OF THE INVENTION

This invention was developed in view of the above problem, an object thereof is to provide a technology capable of contributing to an improvement in battery performance by forming stripe-shaped pattern elements at narrower intervals than before while avoiding contact between the pattern elements in a technology for manufacturing a battery electrode by applying an application liquid containing active material.

To achieve the above object, the present invention is a battery electrode manufacturing method for manufacturing a battery electrode in which a plurality of stripe-shaped active material pattern elements parallel to each other are arranged on a surface of a base material, comprising: a first application step of applying an application liquid prepared by mixing an active material into a liquid in a stripe on the surface of the base material by moving and scanning a nozzle for discharging the application liquid in a predetermined scanning direction relative to the surface of the base material surface; a volatilization step of volatilizing liquid components of the application liquid to form a first active material pattern element by the active material; and a second application step of applying an application liquid containing an active material in a stripe at a position adjacent to the first active material pattern element on the surface of the base material to form a second active material pattern element adjacent to the first active material pattern element by moving and scanning a nozzle for discharging the application liquid in the scanning direction relative to the surface of the base material.

In the thus configured invention, the volatilization step of volatilizing the liquid components from the application liquid applied first is provided between the application of the application liquid to form the first active material pattern element (first application step) and the application of the application liquid to form the second active material pattern element adjacent to the first active material pattern element (second application step) without simultaneously forming the active material pattern elements adjacent to each other.

According to the knowledge of the inventors of this application, since the application liquid for forming active material pattern elements in which an active material is dispersed in a liquid temporarily spreads on a base material when being discharged from a nozzle, the width of the pattern element immediately after the application is slightly larger than that of a discharge opening. Thereafter, the pattern element shrinks as the liquid components are volatilized, wherefore the width of the pattern element after drying is smaller than that immediately after the application.

If the applications of the application liquid are simultaneously performed to form pattern elements adjacent to each other or successively performed without a sufficient time interval for volatilization of the liquid components being set therebetween, there is a higher possibility that the pattern elements touch each other particularly when the interval between the pattern elements is small. This is because the both pattern elements have fluidity and the surface shapes thereof are likely to change in addition to the spread of the width immediately after the application as described above. Further, the both pattern elements are also thought to be pulled toward each other by electrostatic attraction forces, intermolecular forces or the like since the liquid components or their vapors are present between the pattern elements. Therefore, it is difficult to make the interval between the pattern elements sufficiently small.

On the other hand, if the volatilization step is provided between the applications of the both pattern elements, the width of the active material pattern element formed first become smaller due to shrinkage and the fluidity thereof is reduced. Thus, even if the application liquid applied in the later step spreads on the base material, a probability of touching the already formed active material pattern element is largely reduced. In this way, the pattern element interval can be made smaller than before. As just described, according to the invention, it is possible to manufacture a battery electrode having dense stripe-shaped pattern elements at narrower intervals than before while avoiding contact between the pattern elements.

Another aspect of the invention is a battery manufacturing method for manufacturing a battery, comprising: an electrode manufacturing step of manufacturing an electrode by the battery electrode manufacturing method described above; and an electrolyte layer forming step of forming an electrolyte layer covering the active material pattern elements by applying an application liquid containing an electrolyte material to a surface of the electrode where the active material pattern elements are formed.

In the thus configured invention, a battery is manufactured by laminating another functional layer through application on an electrode free from contact between the adjacent pattern elements as described above and including stripe-shaped active material pattern elements arranged at narrow intervals. That is, according to this invention, it is possible to manufacture a high-performance battery including an active material layer formed by stripe-shaped pattern elements arranged at a high density and having a large surface area.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1A and FIG. 1B are drawings which show an example of a battery manufactured by using the present invention;

FIG. 2 is a flow chart which shows a manufacturing method of the embodiment for manufacturing the battery module;

FIG. 3A and FIG. 3B are drawings which show a state of application by the nozzle-scan coating method;

FIGS. 4A to 4D are diagrams which show a problem which can occur when the pattern element interval is made smaller;

FIG. 5 is a flow chart which shows a process of forming the negative-electrode active material layer in this embodiment;

FIGS. 6A to 6C and 7A to 7C are views which diagrammatically show the external appearance and cross-sectional shape respectively of the active material pattern elements formed by the process of FIG. 5;

FIGS. 8A and 8B are views which show a first example and a second example of pattern element formation according to this embodiment; and

FIGS. 9A and 9B are views which show a third example of pattern element formation according to this embodiment.

### DETAILED DESCRIPTION OF THE PREFERRED EMBODIMENTS

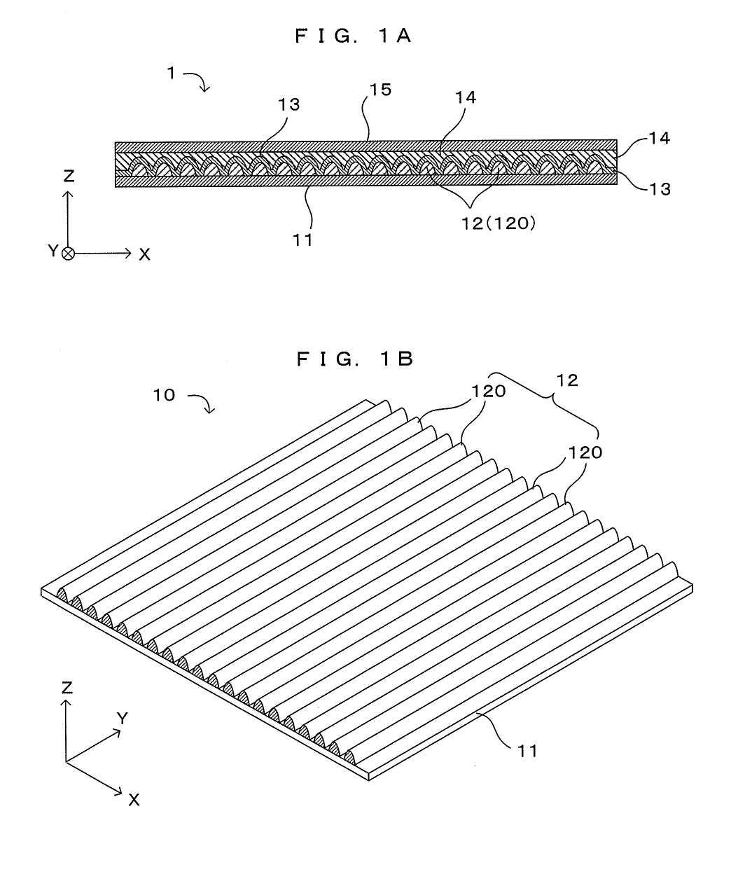

FIG. 1A and FIG. 1B are drawings which show an example of a battery manufactured by using the present invention. More specifically, FIG. 1A shows a cross-sectional structure of a lithium-ion battery module manufactured by an embodiment of the battery manufacturing method according to the invention. FIG. 1B is a schematic diagram which shows a structure of an electrode, which is manufactured by the battery electrode manufacturing method according to the invention, of the battery in FIG. 1A. This lithium-ion battery module 1 has such a structure that a negative-electrode active material layer 12, a solid electrolyte layer 13, a positive-electrode active material layer 14 and a positive-electrode current collector 15 are successively laminated on a surface of a negative-electrode current collector 11. In this specification, X-, Y- and Z-coordinate directions are respectively defined as shown in FIG. 1A.

FIG. 1B shows a structure of a negative electrode 10 formed by laminating the negative-electrode active material layer 12 on the surface of the negative-electrode current collector 11. As shown in FIG. 1B, the negative-electrode active material layer 12 has a line-and-space structure (striped structure) in which a multitude of stripe-shaped pattern elements 120 extending in a Y-direction are arranged at regular intervals in an X-direction. On the other hand, the solid electrolyte layer 13 is a thin film which is formed by a solid electrolyte and has an approximately constant thickness. The solid electrolyte layer 13 uniformly covers the substantially entire upper surface of the electrode 10 in such a manner as to conform to the unevenness on the surface of the electrode 10 in which the negative-electrode active material layer 12 is formed on the negative-electrode current collector 11 as described above.

The lower surface of the positive-electrode active material layer 14 has an uneven structure in conformity with the unevenness on the upper surface of the solid electrolyte layer 13, whereas the upper surface thereof is a substantially flat surface. The positive-electrode current collector 15 is laminated on the upper surface of the positive-electrode active material layer 14, whereby the lithium-ion secondary battery module 1 is formed. A lithium-ion battery is formed by appropriately arranging tab electrodes or laminating a plurality of modules on this lithium-ion battery module 1.

Here, known materials for lithium-ion batteries can be used as materials for the respective layers. For example, a copper foil and an aluminum foil can be respectively used as the negative-electrode current collector 11 and the positive-electrode current collector 15. Further, a material mainly containing LiCoO₂ (LCO) can be, for example, used as a positive-electrode active material and a material mainly containing Li₄Ti₅O₁₂ (LTO) can be, for example, used as a negative-electrode active material. Furthermore, a mixture of polyethylene oxide and polystyrene can be, for example, used as the solid electrolyte layer 13. Note that the materials for the respective functional layers are not limited to these.

The lithium-ion secondary battery module 1 having such a composition and structure is thin and flexible. Since the negative-electrode active material layer 12 is formed to have an uneven space structure as shown and, thereby, increase its surface area with respect to its volume, an area facing the positive-electrode active material layer 14 via the thin solid electrolyte layer 13 can be increased to ensure high efficiency and high output. In this way, the lithium-ion secondary battery having the above structure can be small in size and have high performance.

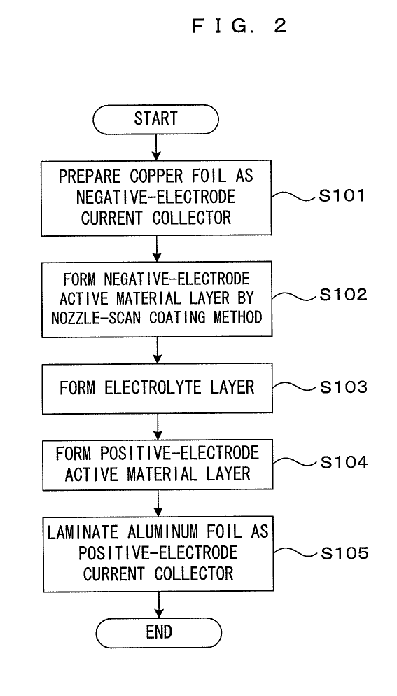

FIG. 2 is a flow chart which shows a manufacturing method of the embodiment for manufacturing the battery module. In this manufacturing method, a metal foil, e.g. a copper foil, which will become the negative-electrode current collector 11, is first prepared (Step S101). In the case of using a thin copper foil, it is difficult to transport and handle this foil. Accordingly, it is preferable to improve transportability, for example, by attaching one surface of the copper foil to a carrier such as a glass plate or a resin sheet.

Subsequently, an application liquid containing a negative-electrode active material is applied to one surface of the copper foil by a nozzle dispensing method, in particular, by a nozzle-scan coating method for relatively moving a nozzle for dispensing the application liquid with respect to an application target surface (Step S102). An organic LTO material containing the negative-electrode active material described above can be, for example, used as the application liquid. A mixture of the above negative-electrode active material, acetylene black or ketjen black as a conduction aid, polyvinylidene fluoride (PVDF), styrene butadiene rubber (SBR), polyvinyl pyrrolidone (PVP), polyvinyl alcohol (PVA) or polytetrafluoroethylene (PTFE) as a binder, N-methyl-2-pyrrolidone (NMP) as a solvent and the like can be used as the application liquid. Note that, besides LTO described above, graphite, metal lithium, SnO₂, alloys and the like can be used as the negative-electrode active material.

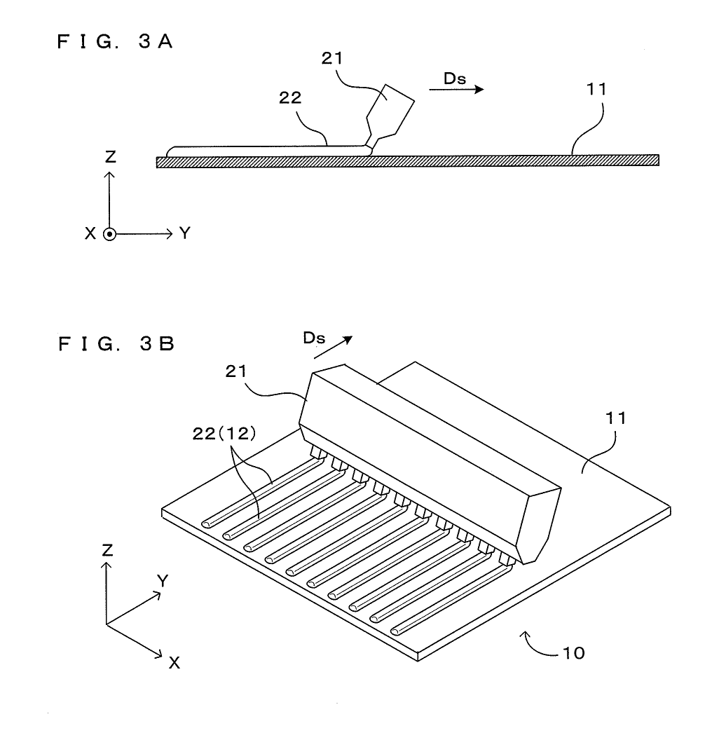

FIG. 3A and FIG. 3B are drawings which show a state of application by the nozzle-scan coating method. More specifically, FIG. 3A is a drawing which shows a side view of the state of application by the nozzle-scan coating method. FIG. 3B is a drawing which shows the same state when viewed from a diagonal upper side. A technology for applying an application liquid to a base material by the nozzle-scan coating method is known and such a known technology can be applied also in this method, wherefore an apparatus construction is not described.

In the nozzle-scan coating method, a nozzle 21 perforated with one or more dispense openings is arranged above a copper foil 11. The nozzle 21 is relatively moved at a constant speed in an arrow direction Ds with respect to the copper foil 11 while dispensing a fixed amount of an application liquid 22 from the dispense opening(s). By doing so, the application liquid 22 is applied on the copper foil 11 in a stripe extending in the Y-direction. By providing the nozzle 21 with a plurality of dispense openings, a plurality of stripes can be formed by one movement. By repeating this movement according to need, the application liquid can be applied in stripes on the entire surface of the copper foil 11. By drying and curing the application liquid, the negative-electrode active material layer 12 is formed on the upper surface of the copper foil 11. A photo-curable resin may be added to the application liquid and the application liquid may be cured by light irradiation after application.

At this point of time, an active material layer 12 is partly raised on the substantially flat surface of the copper foil 11. Thus, as compared with the case where the application liquid is simply applied to have a flat upper surface, a surface area can be increased with respect to the used amount of the active material. Therefore, the area facing a positive-electrode active material layer to be formed later can be increased to ensure a high output.

The flow chart of FIG. 2 is further described. An electrolyte application liquid is applied on the upper surface of a laminated body, which is formed by laminating the negative-electrode active material layer 12 on the copper foil 11, by an appropriate coating method, e.g. a knife coating method or a bar coating method (Step S103). As the electrolyte application liquid, a mixture of a resin as the above polymer electrolyte material such as polyethylene oxide and polystyrene, a supporting salt such as LiPF₆ (lithium hexafluorophosphate) and a solvent such as diethylene carbonate can be used.

The positive-electrode active material layer 14 is formed on a laminated body formed by laminating the copper foil 11, the negative-electrode active material layer 12 and the solid electrolyte layer 13 in this way (Step S104). The positive-electrode active material layer 14 is formed by applying a positive-electrode active material application liquid containing a positive-electrode active material by an appropriate coating method, e.g. a known knife coating method. An aqueous LCO material obtained by mixing the positive-electrode active material, acetylene black as a conduction aid, SBR as a binder, carboxymethylcellulose (CMC) as a dispersant and pure water as a solvent can be, for example, used as the application liquid containing the positive-electrode active material. Besides the above LCO, LiNiO₂, LiFePO₄, LiMnPO₄, LiMn₂O₄ or compounds represented by LiMeO₂ (Me=MₓM_{y}M_{z}; Me, M are transition metal elements and x+y+z=1) such as LiNi_{1/3}Mn_{1/3}Co_{1/3}O₂ and LiNi_{0.8}Co_{0.15}Al_{0.05}O₂ can be used as the positive-electrode active material. Further, known coating methods capable of forming a flat film on a flat surface such as the knife coating method, a bar coating method and a spin coating method can be appropriately employed as the coating method.

By applying the application liquid containing the positive-electrode active material to the laminated body, the positive-electrode active material layer 14 which has a lower surface conforming to the unevenness on the surface of the electrolyte layer 13 and a substantially flat upper surface is formed. A metal foil, e.g. an aluminum foil which will become a positive-electrode current collector 15 is laminated on the upper surface of the positive-electrode active material layer 14 formed in this way (Step S105). At this time, it is desirable to superimpose the positive-electrode current collector 15 on the upper surface of the positive-electrode active material layer 14 formed in previous Step S104 before the positive-electrode active material layer 14 is cured. By doing so, the positive-electrode active material layer 14 and the positive-electrode current collector 15 can be tightly bonded to each other. Since the upper surface of the positive-electrode active material 14 is leveled, the positive-electrode current collector 15 can be easily laminated without forming any clearance. By doing so, the lithium-ion battery module 1 shown in FIG. 1A can be manufactured.

The above method for manufacturing a lithium-ion battery is basically the same as that disclosed in JP2011-070788 described above. However, in this embodiment, a step of forming the negative-electrode active material layer 12 in Step S102 is configured as follows to increase the density of the active material pattern elements 120 in the negative-electrode active material layer 12 by making the intervals between the multitude of stripe-shaped active material pattern elements 120 smaller than before.

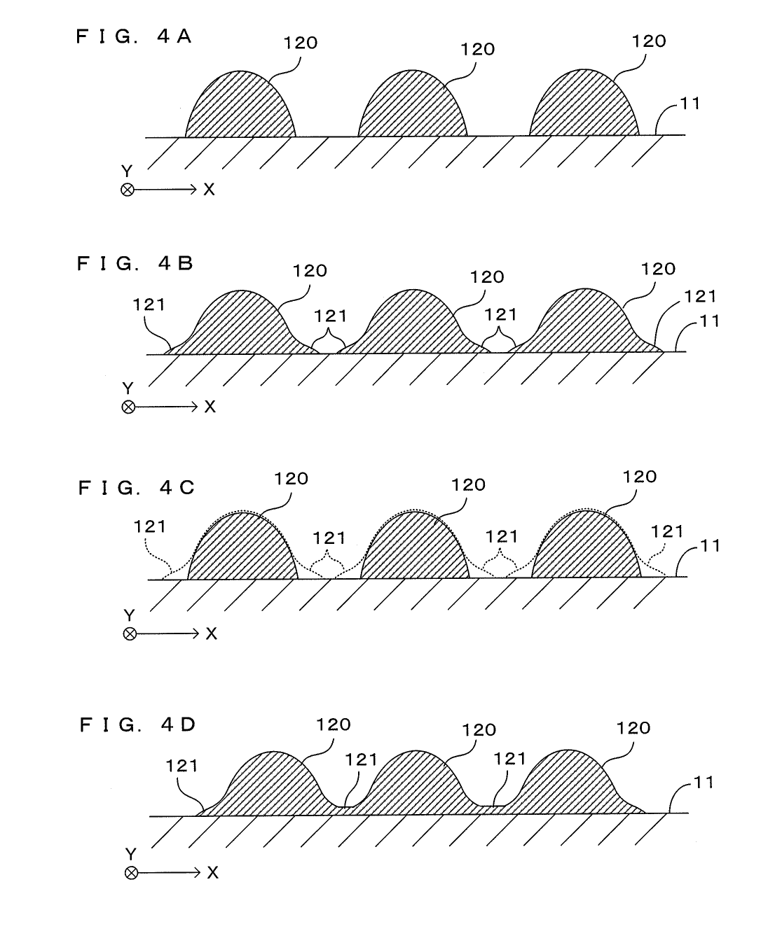

FIGS. 4A to 4D are diagrams which show a problem which can occur when the pattern element interval is made smaller. Strictly speaking, the cross-sectional shape of the active material pattern elements 120 formed on a copper foil 11 as the base material by the discharge of the application liquid from the nozzle 21 depends on the shape of the nozzle discharge openings and the viscosity of the application liquid and is, for example, an upward projecting substantially semicircular shape as shown in FIG. 4A. However, the cross-sectional shape does not remain the same from a highly fluid state immediately after application to a state after curing. That is, in the state immediately after application where many liquid components are contained and fluidity is high, base parts 121 of the substantially semicircular cross section spread in a direction perpendicular to a pattern element extending direction, i.e. in the X-direction as shown in FIG. 4B.

Thereafter, as drying progresses, the pattern elements slightly shrink due to volatilization of the liquid components and, particularly, the base parts 121 of the pattern elements almost disappear as shown in FIG. 4C, whereby an original cross-sectional shape as shown in FIG. 4A is obtained. However, if the interval between the adjacent pattern elements 120 becomes smaller, the base parts 121 may touch each other in a state where the application liquid maintains its fluidity as shown in FIG. 4D, with the result that the adjacent pattern elements may be electrically connected. Particularly, in a state where the fluidity of the application liquid is high, once two pattern elements touch each other at one position, they touch each other in a wide range by the action of surface tension and, in some cases, are completely united.

If the adjacent pattern elements are made of an active material having the same component, such a contact is not thought to become a big program. However, the contact causes the surface area of the active material pattern elements to largely differ from a supposed value and also causes a product-to-product variation to increase. Thus, the contact is disadvantageous in terms of manufacturing a battery with stable performance.

Accordingly, in this embodiment, this problem is solved by forming the negative-electrode active material layer by a method described below. The principle of the method is as follows. As described above, the base parts 121 made by the application liquid 120 applied to the base material 11 temporarily spread around and then the application liquid 120 shrinks and the base parts 121 almost disappear. The pattern elements are likely to touch each other due to mutual approach of the base parts of the adjacent pattern elements in the highly fluid state. This is thought to be caused by the action of electrostatic forces between proximate fluids, mutual attraction forces resulting from intermolecular forces, evaporation of a solvent present between the pattern elements and the like.

Accordingly, if at least one of the adjacent pattern elements has no fluidity, a probability of contact between the pattern elements is largely reduced. That is, if one of the pattern elements, which will be finally adjacent to each other, is formed by application after the other is first formed by application and liquid components are volatilized, a risk of contact between the adjacent pattern elements is fairly reduced.

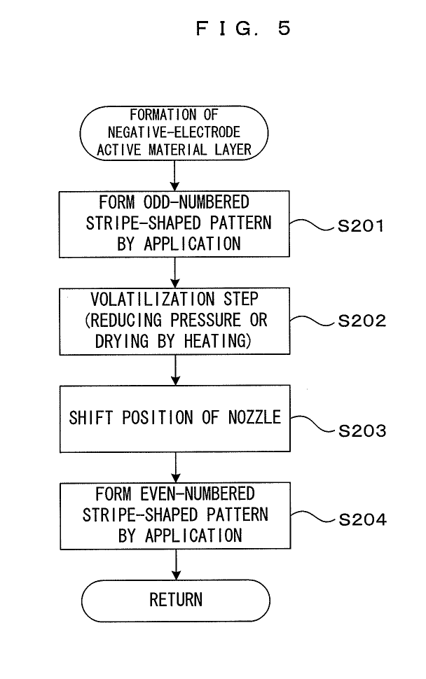

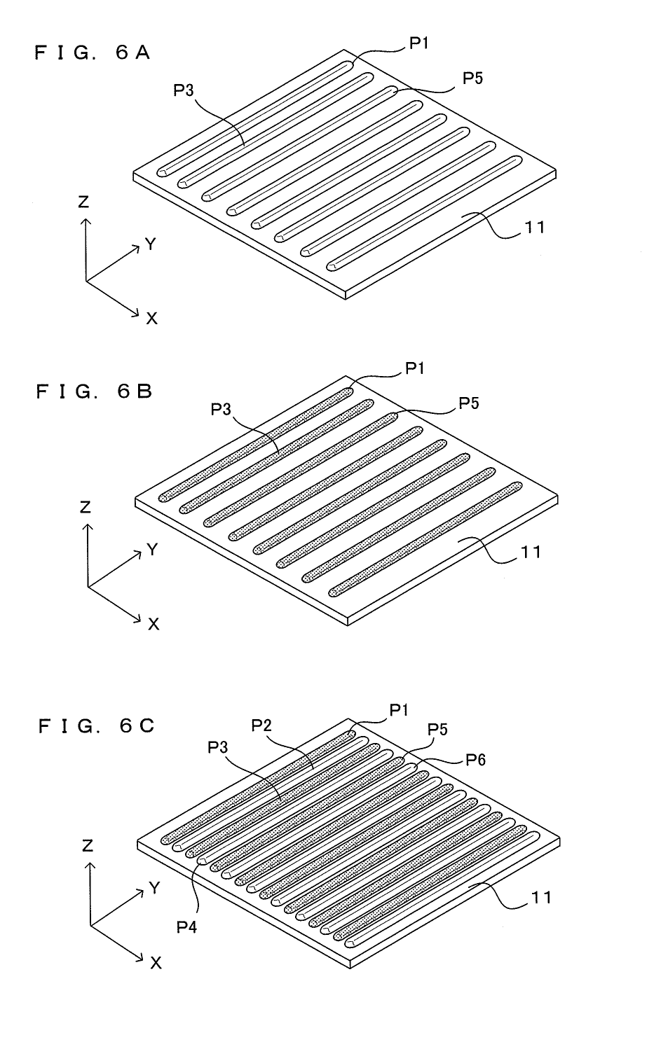

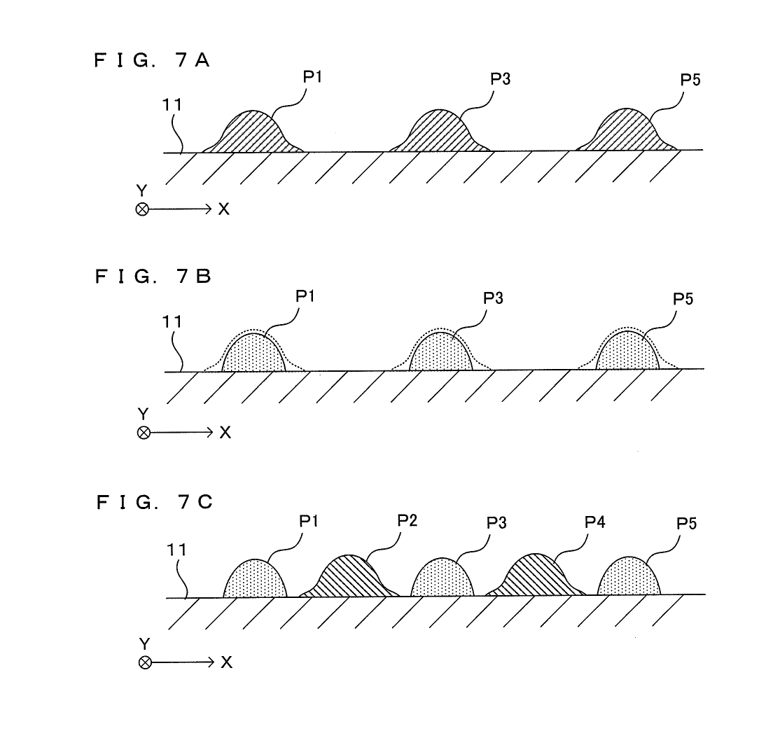

FIG. 5 is a flow chart which shows a process of forming the negative-electrode active material layer in this embodiment. Further, FIGS. 6A to 6C and 7A to 7C are views which diagrammatically show the external appearance and cross-sectional shape respectively of the active material pattern elements formed by the process of FIG. 5. The process shown in FIG. 5 shows a processing of Step S102 of FIG. 2 in more detail. Although the negative-electrode active material layer 12 is merely formed by the nozzle-scan coating method in the above description of Step S102, this process is actually segmentalized into the respective process steps shown in FIG. 5. In this process, a multitude of active material pattern elements 120 formed on the copper foil 11 as the base material are not simultaneously formed, but the adjacent pattern elements are formed with time lags.

That is, as shown in FIG. 5, the stripe-shaped pattern elements corresponding to odd-numbered ones of the pattern elements 120 to be finally formed side by side on the base material 11 in their arrangement order are first formed by application through a scan movement of the nozzle 21 (Step S201). Then, a volatilization step of volatilizing liquid components contained in these pattern elements is performed (Step S202). Thereafter, after the position of the nozzle 21 in the X-direction is shifted by half the arrangement pitch of the discharge openings of the nozzle 21 relative to the base material 11 (Step S203), the nozzle 21 is moved to scan again to form stripe-shaped pattern elements, which will finally become even-numbered pattern elements, between the already formed pattern elements (Step S204).

In a state attained by performing Step S201 of this process, the odd-numbered pattern elements P1, P3, P5, . . . applied on the base material 11 maintain fluidity and have such a cross-sectional shape that base parts thereof spread in the X-direction due to the fluidity as shown in FIGS. 6A and 7A.

In the volatilization step of Step S202, the liquid components are volatilized from the pattern elements P1, P3, P5, . . . formed by the application liquid, for example, by allowing the base material 11 having the application liquid applied thereto to stand still for a predetermined time under a dry atmosphere, heating the base material 11 or reducing an ambient atmospheric pressure. As a result, as shown in FIGS. 6B and 7B, the spread of the base parts of the pattern elements disappears and the cured pattern elements P1, P3, P5, . . . having a substantially semicircular cross section are formed. In FIGS. 6A to 7C, the cured pattern elements whose liquid components are volatilized are shown by hatching with dots, thereby being distinguished from the pattern elements that are not cured yet.

In this state, application in Step S204 is performed. At this time, as shown in FIGS. 6C and 7C, base parts of pattern elements P2, P4, P6, . . . applied in this step spread due to fluidity, but the spread of the base parts of the pattern elements P1, P3, P5, . . . adjacent thereto is already solved. Thus, the base parts are prevented from approaching and touching each other between the adjacent pattern elements.

In this way, in this embodiment, two stripe-shaped pattern elements, which will be adjacent to each other in the finally formed electrode 10, are applied and formed at different timings and the step of allowing the liquid components to volatilize from the application liquid applied first is provided between the applications of the both. Since contact between the adjacent pattern elements is avoided by doing so, the stripe-shaped active material pattern elements can be formed at a higher density than before by making the interval between the pattern elements narrower than before.

Note that a tiny amount of the active material is thought to be contained in the base parts of the pattern elements that disappear due to volatilization of the liquid components. Accordingly, thin films of the active material may remain in parts of the base material 11 after volatilization of the liquid components, and these may possibly cause connection between the adjacent pattern elements. However, unlike a short circuit, for example, between wiring pattern elements on a printed board, these pattern elements are active material pattern elements having the same composition in the battery electrode. Therefore, the influence of the connection is thought to be limited.

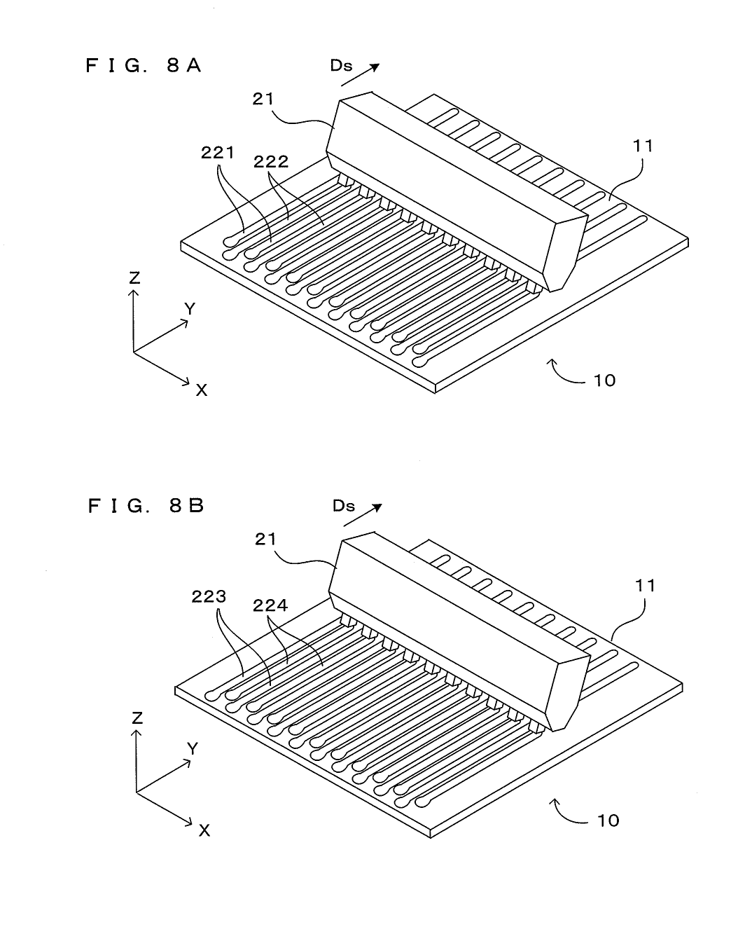

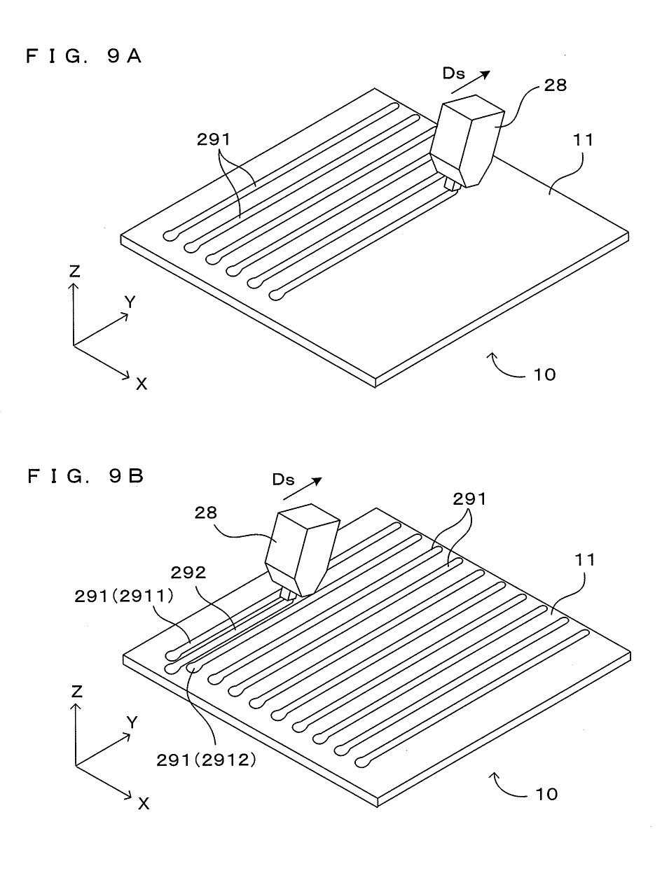

Next, several modes of a specific manufacturing method for the battery electrode based on the principle as described above are successively described with reference to FIGS. 8A to 8B and 9A to 9B.

FIGS. 8A and 8B are views which show a first example and a second example of pattern element formation according to this embodiment. Application of the coating method shown in FIG. 3B is, for example, thought for forming respective pattern elements adjacent to each other in different timings as described above. As shown in FIG. 3B, the nozzle 21 in which a multitude of discharge openings for discharging the application liquid are arranged in the X-direction is moved to scan in the Y-direction relative to the surface of the base material 11. By doing so, it is possible to form a plurality of stripe-shaped pattern elements 22 parallel to each other and extending in the Y-direction (first application step). After the plurality of pattern elements are formed in this way, the position of the nozzle 21 in the X-direction relative to the base material 11 is moved by half the arrangement pitch of the already formed pattern elements in the X-direction, i.e. by half the arrangement pitch of the discharge openings of the nozzle 21. Thereafter, by moving of the nozzle 21 in the Y-direction again, one new pattern element can be formed between each pair of already formed pattern elements (second application step). In this way, the pattern elements can be formed at twice as high a density (i.e. ½ arrangement pitch) as before.

At this time, as shown in FIG. 8A, the position of the nozzle 21 in the Y-direction relative to the base material 11 is made different at the start of application. By doing so, pattern elements are formed in an offset arrangement in which the pattern element start positions in the Y-direction alternately differ between the adjacent pattern elements. This is done for the following reason. In the nozzle-scan coating method for applying the application liquid to the base material by discharging the application liquid from the nozzle moving relative to the base material, the application liquid first adhered to the base material flows and spreads around due to the stay of the application liquid at the nozzle openings at the start of application and a relationship between a scanning movement and an operation timing. As a result, the pattern element start ends may become wider than they are supposed to be.

Particularly when the pattern element interval is made smaller than before, the adjacent pattern elements may touch each other due to the spread of the pattern element start ends. Even though partial contact between the pattern elements having the same composition does not become a big program as described above, contact at the pattern element start ends in this case causes the application liquid to be pulled toward the already formed pattern elements due to surface tension of the application liquid and wettability to the already formed pattern elements. Thus, even if the nozzle is moved to scan in this state, separation of the pattern elements that have once touched each other cannot be expected and it is not possible to form pattern elements at predetermined intervals.

By making the start positions of the pattern elements adjacent to each other different in the Y-direction, contact between the pattern elements due to the spread of such pattern elements can be avoided. It is not an essential requirement to arrange the start positions in an offset manner, but such an offset arrangement is rational to form a multitude of pattern elements parallel to each other with the start positions made different between the adjacent pattern elements. Further, all the pattern elements can be formed using a single nozzle in which discharge openings are arranged in a row as in an example shown in FIGS. 8. Note that the following two positional relationships are thought as those between the pattern elements respectively formed by scanning movements of the nozzle in forward and backward directions.

In the first example shown in FIG. 8A, second application for pattern elements 222 is started from a side upstream (lower left side in FIG. 8A) of the start positions of pattern elements 221 already formed on the surface of the base material 11 by the first scanning in a moving/scanning direction Ds of the nozzle 21. In this case, the application liquid is applied by the second scanning in a direction toward a downstream side between the pattern element start ends formed by the first scanning. In such a case, since the application liquid is applied by the second scanning with a stable width between the already formed pattern elements after spreading at positions away from the already formed pattern elements, contact with the already formed pattern elements caused by the spread of the application liquid can be reliably prevented.

By providing the step of volatilizing the liquid components from the application liquid applied by the first scanning and allowing the pattern elements to shrink between the first scanning and the second scanning, it is possible to prevent contact between the pattern elements due to the base parts of the respective pattern elements spreading in the X-direction and form the stripe-shaped pattern elements at a high density.

On the other hand, in the second example shown in FIG. 8B, second application for pattern elements 224 is started from a side downstream of the start positions of pattern elements 223 already formed on the surface of the base material 11 by the first scanning in the moving/scanning direction Ds of the nozzle 21. Also in such a case, contact of the application liquid with the already formed pattern elements can be prevented. Further, the tips of the nozzle 21 do not come into contact with and damage the already formed pattern elements when passing between the start ends of the already formed pattern elements.

FIGS. 9A and 9B are views which show a third example of pattern element formation according to this embodiment. In the above respective examples, a plurality of pattern elements are simultaneously formed using the nozzle in which a plurality of discharge openings is arranged in the X-direction. However, an electrode 10 having a similar configuration can also be manufactured also using a nozzle including a single discharge opening. That is, as shown in FIG. 9A, a plurality of pattern elements 291 parallel to each other and extending in the Y-direction are formed by scan movement of a nozzle 28 having a single discharge opening in the Y-direction every time the position of the nozzle 28 in the X-direction relative to the base material 11 is changed by a constant feed pitch (first application step).

Thereafter, the nozzle 28 is moved to a position which is located between the firstly formed pattern element 2911 and the secondly formed pattern element 2912 and different from the start positions of these pattern elements 2911, 2912 in the Y-direction. The nozzle 28 is moved to scan in the Y-direction every time the position thereof in the X-direction relative to the base material 11 is changed by the same feed pitch as described above (second application step). In this way, new pattern elements 292 can be formed between the already formed pattern elements 291. Similar to the previous example, the start positions of the new pattern elements 292 can be either upstream or downstream of the start positions of the already formed pattern elements 291 in the moving/scanning direction Ds.

In this example, after a plurality of pattern elements 291 are successively formed one by one in the first application step, the nozzle 28 is returned to a position adjacent to the first position and the second application step is performed. Thus, there is a large difference between a formation timing of the pattern element 291 formed by the first application step and that of the pattern element 292 formed at the position adjacent to the pattern element 291 by the second application step. Thus, when the first application step ends, i.e. when the formation of the last pattern element in the first application step ends, volatilization of the liquid components from the pattern elements formed at first is thought to have progressed to a certain degree. Further, for the pattern elements formed at a later timing of the first application step, volatilization of the liquid components is expected to progress while the pattern elements are successively formed in the second application step.

From this, a time taken for the volatilization step provided between the first application step and the second application step can be made shorter than in the above example and an increase in throughput caused by forming the pattern elements one by one can be suppressed. Particularly, in such a situation where volatilization of the liquid components from the pattern elements formed at first has sufficiently progressed when the first application step ends, a transition can be immediately made to the second application step after the end of the first application step. In this case, it can be said that the volatilization step for the already formed pattern elements is simultaneously performed while the pattern elements are formed by the first application step.

Note that, in these application examples, the end positions of the pattern elements are not particularly limited and may be located at the same position in the Y-direction for the following reason. At the end positions of application, notable spread of the pattern elements as at the start positions is not found. Even if contact may be established due to the spread of the pattern elements at their ends, the contact is limited to that position.

As described above, in this embodiment, the pattern elements that will be arranged adjacent to each other on the finally formed electrode are not simultaneously formed. Instead of this, after one pattern element is formed by application, the other pattern element is formed by application by way of such a volatilization step in which the liquid components are sufficiently volatilized. By doing so, after the base parts of the pattern element formed first shrink and almost disappear, the pattern element adjacent to the former pattern element is formed. Thus, contact between the pattern elements is avoided which results from mutual approach of the base parts when these pattern elements are simultaneously formed.

Therefore, active material pattern elements can be formed at narrower intervals than before by preventing a disorder of the pattern element shape resulting from contact of the adjacent pattern elements at the pattern element start ends. As a result, in this embodiment, it is possible to manufacture a battery electrode used to manufacture a battery with good capacity and charge/discharge characteristics.

As described above, in this embodiment, the pattern elements P1, P3, P5, . . . in FIG. 6A, the pattern elements 221 in FIG. 8A, the pattern elements 223 in FIG. 8B, the pattern elements 291 in FIG. 9A and the like correspond to “first active material pattern elements” of the invention. Further, the pattern elements P2, P4, P6, . . . in FIG. 6C, the pattern elements 222 in FIG. 8A, the pattern elements 224 in FIG. 8B, the pattern elements 292 in FIG. 9B and the like correspond to “second active material pattern elements” of the invention.

Note that the invention is not limited to the above embodiment and various changes other than the above can be made without departing from the gist thereof. For example, in the above embodiment, the invention is applied to the method for manufacturing the all-solid-state battery by successively laminating the solid electrolyte layer, the positive-electrode active material layer and the positive-electrode current collector on the negative electrode 10 formed by the method described above. However, the invention can also be applied to a technology for manufacturing a battery not only using such a solid electrolyte, but also an electrolyte layer formed by an electrolytic solution and a technology for manufacturing an electrode for the battery.

Further, although the start positions of the pattern elements in the Y-direction are made different from each other between the adjacent pattern elements in the above embodiment, the invention can be applied not only in a structure in which the start positions of pattern elements are changed in this way, but also in the case of forming pattern elements whose start positions in the Y-direction are aligned.

Further, the materials of the current collectors, the active materials, the electrolyte and the like illustrated in the above embodiment are only examples and there is no limitation to these. Also in the case of manufacturing a lithium-ion battery using other materials used as constituent materials of lithium-ion batteries, the manufacturing method of the invention can be preferably applied. Further, without limitation to lithium-ion batteries, the invention can be applied to manufacturing in general of chemical batteries using other materials and electrodes used therein.

Although a mode of moving and scanning the nozzle relative to the base material is illustrated to facilitate the understanding of the principle of the invention in the above description, relative movements of the base material and the nozzle can be realized by moving either the nozzle or the base material. Rather, in terms of preventing a disorder of application due to vibration applied to the nozzle, it is more preferable to fix the nozzle and move the base material.

Further in the invention, for example, in the first application step, the application liquid may be applied in a plurality of stripes parallel to each other; and in the second application step, the application liquid may be applied between the plurality of stripes formed in the first application step. For example, in the case of forming a multitude of stripe-shaped pattern elements, it is possible to form the odd-numbered stripe-shaped pattern elements in an arrangement of the pattern elements to be finally formed in the first application step and the even-numbered stripe-shaped pattern elements in the second application step. Since the formation of the pattern element and that of the pattern element adjacent to the former pattern element are respectively performed with the volatilization step performed therebetween, contact between the pattern elements can be avoided.

A possible first example of that specific mode is as follows. In the first application step, the application liquid is applied in a plurality of stripes by alternately performing a scanning movement of the nozzle relative to the surface of the base material and a pitch-feed movement of moving the nozzle by a predetermined pitch in a direction perpendicular to the scanning direction relative to the surface of the base material. Further, in the second application step, the application liquid is applied in stripes between the plurality of first active material pattern elements by alternately performing a scan movement of the nozzle relative to the surface of the base material and a pitch-feed movement in the same direction as the pitch-feed movement in the first application step.

In the first application step of this case, a plurality of active material pattern elements parallel to each other are successively formed on the base material by repeating the scan movement of the nozzle while shifting the position of the nozzle by the pitch relative to the base material in the direction perpendicular to the scanning direction. At this time, the pattern elements arranged adjacent to each other will not be adjacent in a finally manufactured battery electrode. That is, the pattern elements adjacent to the respective pattern elements thus formed are successively formed in the second application step as in the first application step.

In this case, there is a sufficient time interval between a timing at which the pattern elements are applied and formed first in the first application step and a timing at which the pattern elements are applied and formed at positions adjacent to the former pattern elements in the second application step by setting the same direction of the pitch-feed movement in the first and second application steps. Since this interval serves as at least a part of the volatilization step for volatilizing the liquid components from the application liquid applied first, a process time supposed to be separately provided for the volatilization step can be shortened or omitted.

Further, a possible second example of the specific mode of the invention is as follows. In the first application step, the application liquid is applied in a plurality of stripes by moving and scanning a nozzle, in which a plurality of discharge openings for discharging the application liquid are arranged at equal intervals in the direction perpendicular to the scanning direction, in the scanning direction. Further, in the second application step, the application liquid is applied in stripes between a plurality of active material pattern elements by moving and scanning the nozzle used in the first application step in the scanning direction after moving the nozzle by half the arrangement pitch of the discharge openings in the direction perpendicular to the scanning direction.

Since a plurality of pattern elements can be simultaneously formed by one nozzle scanning movement in such an operation, a battery electrode including a multitude of pattern elements can be manufactured in a short time. In this case, instead of simultaneously forming the pattern elements that will be finally adjacent on the base material, alternate pattern elements in the arrangement of the pattern elements are simultaneously formed and the pattern elements to be arranged therebetween are formed after the volatilization step, whereby contact between the adjacent pattern elements is avoided.

Further, in the volatilization step of the invention, the liquid components may be volatilized by heating the application liquid applied to the surface of the base material or reducing an ambient atmospheric pressure. The liquid components of the application liquid are gradually volatilized for a while after the application, but volatilization of the liquid components can be more promoted and a process time can be shortened by heating the application liquid or reducing an ambient atmospheric pressure.

Further, a start position of the first active material pattern element and a start position of the second active material pattern element may be made different from each other in the scanning direction. In the case of applying the application liquid in stripes by moving and scanning the nozzle discharging the application liquid relative to the base material, the application liquid may excessively adhere to the base material at application start positions and thereby pattern element start ends may be wider than the other parts. If the width of the pattern element increases in this way in each of the adjacent pattern elements, the pattern elements may touch each other. However, this problem can be avoided by making the start positions in the scanning direction different between the adjacent pattern elements.

This invention can be preferably applied to a technology for manufacturing a battery electrode using an active material and manufacturing a battery using this electrode and particularly can provide a battery with good capacity and charge/discharge characteristics by forming a plurality of stripe-shaped active material pattern elements at a high density on a base material.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is clamed is:

1. A battery electrode manufacturing method for manufacturing a battery electrode in which a plurality of stripe-shaped active material pattern elements parallel to each other are arranged on a surface of a base material, comprising:
a first application step of applying an application liquid prepared by mixing an active material into a liquid in a stripe on the surface of the base material by moving and scanning a nozzle for discharging the application liquid in a predetermined scanning direction relative to the surface of the base material surface;
a volatilization step of volatilizing liquid components of the application liquid to form a first active material pattern element by the active material; and
a second application step of applying an application liquid containing an active material in a stripe at a position adjacent to the first active material pattern element on the surface of the base material to form a second active material pattern element adjacent to the first active material pattern element by moving and scanning a nozzle for discharging the application liquid in the scanning direction relative to the surface of the base material.

2. The battery electrode manufacturing method according to claim 1, wherein:
in the first application step, the application liquid is applied in a plurality of stripes parallel to each other; and
in the second application step, the application liquid is applied between the plurality of stripes formed in the first application step.

3. The battery electrode manufacturing method according to claim 2, wherein:
in the first application step, the application liquid is applied in the plurality of stripes by alternately performing a scan movement of the nozzle relative to the surface of the base material and a pitch-feed movement of moving the nozzle by a predetermined pitch in a direction perpendicular to the scanning direction relative to the surface of the base material; and
in the second application step, the application liquid is applied in strips between the plurality of first active material pattern elements by alternately performing a scan movement of the nozzle relative to the surface of the base material and a pitch-feed movement in the same direction as the pitch-feed movement in the first application step.

4. The battery electrode manufacturing method according to claim 2, wherein:
in the first application step, the application liquid is applied in the plurality of stripes in the scanning direction by moving and scanning the nozzle, in which a plurality of discharge openings for discharging the application liquid are arranged at equal intervals in a direction perpendicular to the scanning direction, in the scanning direction; and
in the second application step, the application liquid is applied in stripes between the plurality of first active material pattern elements by moving and scanning the nozzle used in the first application step in the scanning direction after moving the nozzle by half the arrangement pitch of the discharge openings in the direction perpendicular to the scanning direction.

5. The battery electrode manufacturing method according to claim 1, wherein in the volatilization step, the liquid components are volatilized by heating the application liquid applied to the surface of the base material or reducing an ambient atmospheric pressure.

6. The battery electrode manufacturing method according to claim 1, wherein a start position of the first active material pattern element and a start position of the second active material pattern element are made different from each other in the scanning direction.

7. A battery manufacturing method, comprising:
an electrode manufacturing step of manufacturing an electrode by the battery electrode manufacturing method according to claim 1; and
an electrolyte layer forming step of forming an electrolyte layer covering the active material pattern elements by applying an application liquid containing an electrolyte material to a surface of the electrode where the active material pattern elements are formed.
